(19) United States
(12) Patent Application Publication
(10) Pub. No.: US 2008/0198296 A1
(43) Pub. Date: Aug. 21, 2008

(54) LIQUID CRYSTAL DISPLAY DEVICE, BACKLIGHT MODULE AND FABRICATION METHOD THEREOF

(75) Inventors: Chang-Sheng Chu, Hsinchu City (TW); Yu-Tang Li, Taipei County (TW); Cheng-Lin Yang, Taoyuan County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/759,156

(22) Filed: Jun. 6, 2007

(30) Foreign Application Priority Data
Feb. 16, 2007 (TW) TW96106104

(51) Int. Cl. G02F 1/13357; F21V 7/00; H01J 9/00

(52) U.S. Cl. 349/64; 362/612; 445/23

(57) ABSTRACT

The invention provides a liquid crystal display device, backlight module and method for fabricating the same. The backlight module comprises a frame; a plurality of light-emitting diodes disposed on a bottom surface of the frame; and a mixing light plate disposed over the light-emitting diodes. The backlight module further comprises a diffusion plate disposed on the mixing light plate and a reflective layer formed on an inner sidewall and the bottom surface of the frame. The backlight module has a high luminous uniformity and efficiency by the mixing light plate.

### BACKGROUND OF THE INVENTION

1. Field of the Invention

The invention relates to backlight modules and liquid crystal display devices, and more particularly to a backlight module and liquid crystal display device having high luminous efficiency.

2. Description of the Related Art

As the demand for display device components, for example, backlight modules, increases, light-emitting diodes (LEDs), providing high brightness, no pollution, and high color reappearance, have become popular as a light source of backlight module.

When the light-emitting diodes acts as the light source of the backlight module, light emitted is uniform since the diodes are a point light source. Additionally, when mono-chrome light-emitting diodes, for example, red, green and blue color light-emitting diodes, are used, light emitted therefrom is mixed. After light mixing, however, luminous efficiency of the backlight module is reduced.

Thus, a backlight module having an improved luminous uniformity is needed to increase luminous efficiency.

### BRIEF SUMMARY OF INVENTION

Accordingly, an exemplary embodiment of a backlight module comprises a frame; a plurality of light-emitting diodes disposed on a bottom surface of the frame; and a mixing light plate disposed over the light-emitting diodes. The backlight module further comprises a diffusion plate disposed on the mixing light plate and a reflective layer formed on an inner sidewall and the bottom surface of the frame. The backlight module provides a uniform light via the mixing light plate, and luminous efficiency of the backlight module is increased.

Also provided is a liquid crystal display device. An exemplary embodiment of the liquid crystal display device comprises a frame; a plurality of light-emitting diodes disposed on a bottom surface of the frame; a mixing light plate disposed over the light-emitting diodes; a diffusion plate disposed on the mixing light plate; and a liquid crystal display panel disposed on the diffusion plate. The liquid crystal display device further comprises a brightness enhancement film (BEF) between the diffusion plate and mixing light plate.

The invention further provides a method for fabricating a backlight module. The method comprises providing a frame having a reflective layer formed therein; disposing a plurality of light-emitting diodes on a bottom surface of the frame; and disposing a mixing light plate over the light-emitting diodes.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIGS. 1 and 2 are top plan views of a mixing light plate according to the embodiments of the invention;

FIG. 3 is a cross-sectional view along a line A-A′ in FIG. 2;

FIG. 4 is a cross-sectional view of a liquid crystal display device according to an embodiment of the invention;

FIG. 5 is a cross-sectional view of a backlight module according to an embodiment of the invention;

FIG. 6 is a luminous energy distribution diagram of a backlight module without a mixing light plate; and

FIG. 7 is a luminous energy distribution diagram of a backlight module with a mixing light plate according to an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

In FIG. 1, a reflective layer pattern 4, as referred to as a patterned layer is formed on a surface of a substrate 6 to complete a mixing light plate 2. In an embodiment, the substrate 6 is preferably rigid or flexible material, for example, polymer comprising polyethylene (PE), polymethy methacrylate (PMMA), plastic or glass. In one embodiment, the reflective layer pattern 4 is preferably metal such as aluminum (Al), silver (Ag), gold (Au), copper (Cu) or alloys thereof. In another embodiment, the reflective layer pattern 4 may be a light shielding material capable of absorbing light or any suitable opaque material.

In an exemplary embodiment, a reflective layer (not shown) is first formed on a surface of the substrate 6 followed by patterning the reflective layer to form the reflective layer pattern 4. Preferably, the reflective layer is formed on the surface of the substrate 6 by physical vapor deposition (PVD) such as sputtering, electroplating, or evaporation or chemical vapor deposition (CVD) such as plasma enhanced chemical vapor deposition (PECVD). In this case, the reflective layer is preferably patterned by, for example, lithographic and etching process or laser direct writing (laser sculpturing). In some embodiments, the reflective layer pattern 4 may be directly formed on the surface of the substrate 6 by processes such as screen printing or ink-jet printing.

Note that the reflective layer pattern 4 may be circular, triangular, polygonal or any suitable shape. The reflective layer patterns 4 may also be different in dimension or size from each other. In an exemplary embodiment, the reflective layer patterns 4 may be circular with dimensions different from each other, as shown in FIG. 1.

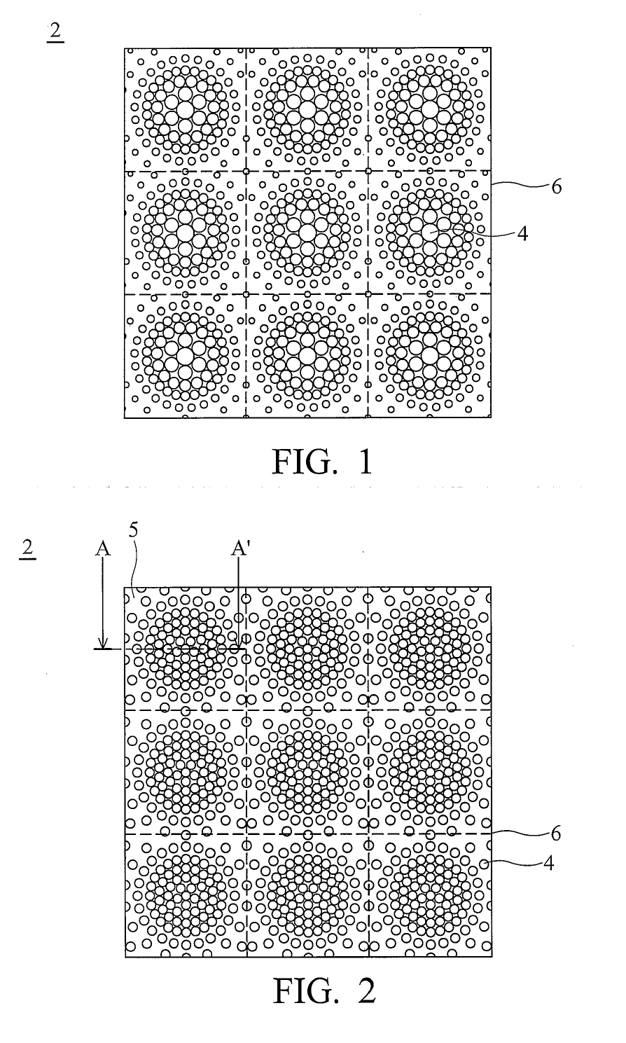

In FIG. 2, the reflective layer patterns 4, circular with dimensions the same as each other according to another embodiment of the invention, are formed on the surface of the substrate 6. The surface of the substrate 6 corresponding to a light source such as light-emitting diode (LED) may be divided into a plurality of mixing light pattern units 5. In one embodiment, a backlight module comprises 9 light-emitting diodes, thus, the surface of the substrate 6 may be divided into 9 mixing light pattern units 5. That is, the number of the mixing light pattern units 5 is determined by light-emitting diodes.

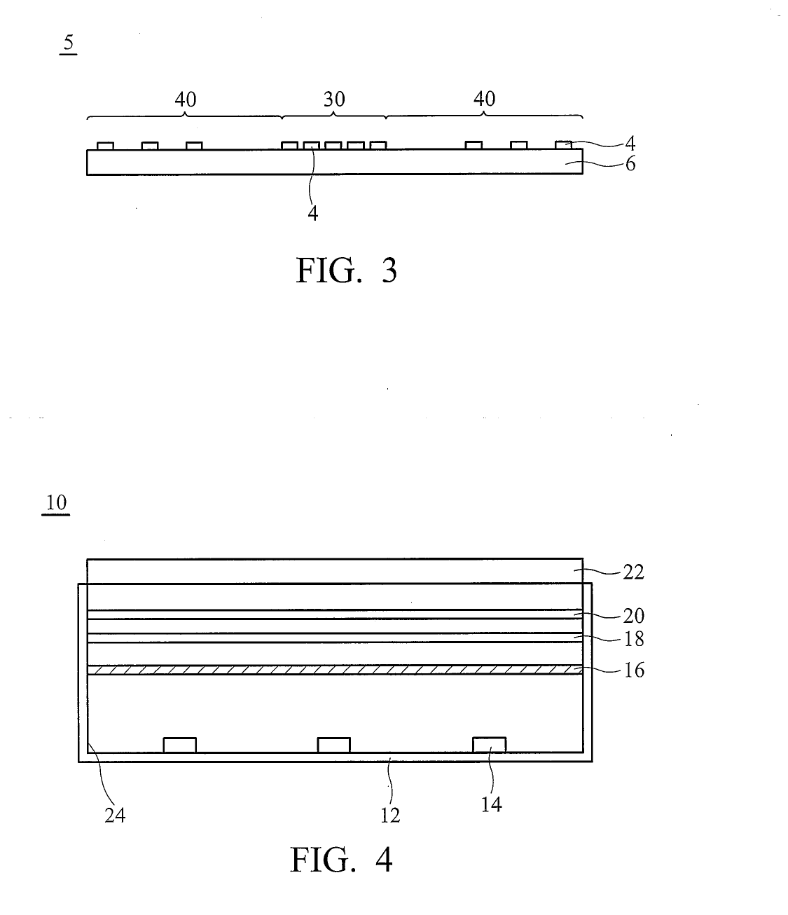

FIG. 3 is a cross-sectional view of mixing light plate 2 taken on a line A-A′ in FIG. 2. The each mixing light pattern unit 5 on the surface of the substrate 6 may be divided into a central area 30 and a peripheral area 40 by distances between the surface of the substrate 6 and the light source. In some embodiments, a distance between the central area 30 and the light source such as light-emitting diode is less than that between the peripheral area 40 and the light source such as light-emitting diode. That is, the central area 30 is close to the light-emitting diode and the peripheral area 40 is far from the light-emitting diode.

As shown in FIG. 3, the reflective layer pattern 4 is formed on the central area 30 and peripheral area 40 of the surface of the substrate 6, respectively. In an embodiment, a distribution density of the reflective layer pattern 4 in the central area 30 is more than that of the reflective layer pattern 4 in the peripheral area 40. In another embodiment, the central area 30 has transparency less than peripheral area 40. In yet another embodiment, a distance between the reflective layer patterns 4 in central area 30 is less than that between the reflective layer patterns 4 in peripheral area 40.

In FIG. 1, the reflective layer pattern 4 in the central area of mixing light pattern units on substrate 6 may be circular with a dimension exceeding that in peripheral area of mixing light pattern units on substrate 6. The dimension of the reflective layer pattern 4 may be gradually become small from the central area to peripheral area of mixing light pattern units.

In FIG. 2, the reflective layer pattern 4 in the central area of mixing light pattern units on substrate 6 may be circular with a dimension the same as that in peripheral area of mixing light pattern units on substrate 6. A distribution density of reflective layer pattern 4 disposed on the surface of the substrate 6 may gradually become sparse from the central area to peripheral area of mixing light pattern unit.

Note that the distribution density of the reflective layer pattern 4 is related to luminous energy of light source. Thus, the previous distribution density of the reflective layer pattern 4 is only used to describe the embodiments of the invention, and is not limited thereto. For example, the distribution density of the reflective layer pattern 4 in the central area close to the light source may be less than the distribution density of the reflective layer pattern 4 in the peripheral area far from the light source.

FIG. 4 is a cross-sectional view of liquid crystal display device 10 according to an embodiment of the invention. The liquid crystal display device 10 comprises a frame 12, a plurality of light-emitting diodes 14, a mixing light plate 16, a diffusion plate 18 and a liquid crystal display panel 22. The light-emitting diodes 14 are disposed on a bottom surface of the frame 12 to provide light for the liquid crystal display device 10. A reflective layer 24, also referred to as a patterned layer is then formed on the bottom surface and an inner sidewall of the frame 12 to reflect light in the backlight module of the liquid crystal display device 10 for enhancing luminous efficiency, as shown in FIG. 4. The mixing light plate 16 is subsequently disposed on the light-emitting diodes 14 to mix light from the light-emitting diodes 14. The mixing light plate 16 further reflects a portion of light to a space between the mixing light plate 16 and the frame 12 for increasing luminous efficiency.

Thereafter, the diffusion plate 18 is disposed on the mixing light plate 16 to thoroughly mix light through mixing light plate 16. A brightness enhancement film (BEF) 20 is then disposed on the diffusion plate 18 to enhance brightness of light through the diffusion plate 18. The brightness enhancement film 20 is preferably a prism system capable of changing light path. The liquid crystal display panel 22 is subsequently disposed on the brightness enhancement film 20 to display images.

Preferably, the light-emitting diodes 14 are white light-emitting diodes or an array of blue, green and red light-emitting diodes. The frame 12 is preferably polymer, metal or suitable material.

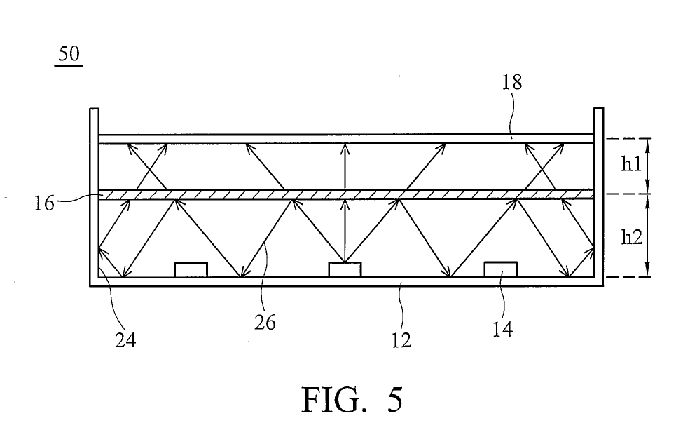

FIG. 5 shows a backlight module 50 according to an embodiment of the invention. The backlight module 50 comprises a frame 12, a plurality of light-emitting diodes 14 and a mixing light plate 16. In FIG. 5, the frame 12 is first provided and the light-emitting diodes 14 are disposed thereon. A reflective layer 24, also referred to as a patterned layer is formed on a bottom surface and an inner sidewall of the frame 12 to reflect light inside the backlight module 50 for enhancing luminous efficiency, as shown in FIG. 5. The mixing light plate 16 is then disposed over the light-emitting diodes 14 to mix light from light-emitting diodes 14 and reflect a portion of light to a space between the mixing light plate 16 and the frame 12 for increasing luminous efficiency. A diffusion plate 18 is subsequently disposed on the mixing light plate 16 to thoroughly mix light through the mixing light plate 16 as shown in FIG. 5.

It is appreciated that while the invention is described with respect to the embodiments in a direct backlight module, the scope of the invention may also be applied to edge backlight modules.

In one embodiment, when the light-emitting diodes emit light, a portion of light may pass through a region of the mixing light plate 16 not forming a reflective layer pattern, and the others may be reflected to the inner backlight module 50 by reflective layer pattern formed on mixing light plate 16. That is, the mixing light plate is capable of filtering, which permits light to pass and reflect. Light in a space between the mixing light plate 16 and the frame 12 may be reflected many times by the reflective layer 24 on the bottom surface and inner sidewall of the frame 12, then pass through the mixing light plate 16 to diffusion plate 18.

The central area of mixing light pattern unit on the surface of the mixing light plate 16 has a distribution density of reflective layer pattern more than in the peripheral area of mixing light pattern unit. Therefore, the central area close to the light-emitting diode 14 has transparency less than that of the peripheral area. There is high luminous energy in an area close to light-emitting diode such as central area, and there is weak luminous energy in an area far from light-emitting diode such as peripheral area, thus, the luminous energy passed through the mixing plate 16 may be equalized by different transparency of mixing light pattern unit. Furthermore, because light in the space between the mixing light plate and frame may pass through diffusion plate by reflecting repeatedly, luminescence efficiency is increasing without losing light.

Furthermore, light through the diffusion plate 18 of the backlight module according to the invention may be further mixed or equalized by adjusting a distance between the diffusion plate 18 and mixing light plate 16. In one embodiment, a distance h2 between the mixing light plate 16 and a bottom surface of the frame 12 may be more than a distance h1 between the mixing light plate 16 and diffusion plate 18. Preferably, the distance h2 may be between about 1 cm and 2 cm and distance h1 may be between about 0.5 cm and 1.5 cm. In some embodiments, the distance h2 between the mixing light plate 16 and the bottom surface of the frame 12 may also be equal to or less than two thirds the distance between the diffusion plate 18 and the bottom surface of the frame 12 (h1+h2).

In an embodiment, the backlight module may optionally use the mixing light plate 16 in place of the diffusion plate 18. That is, the mixing light plate 16 may only be disposed in the backlight module without the diffusion plate 18.

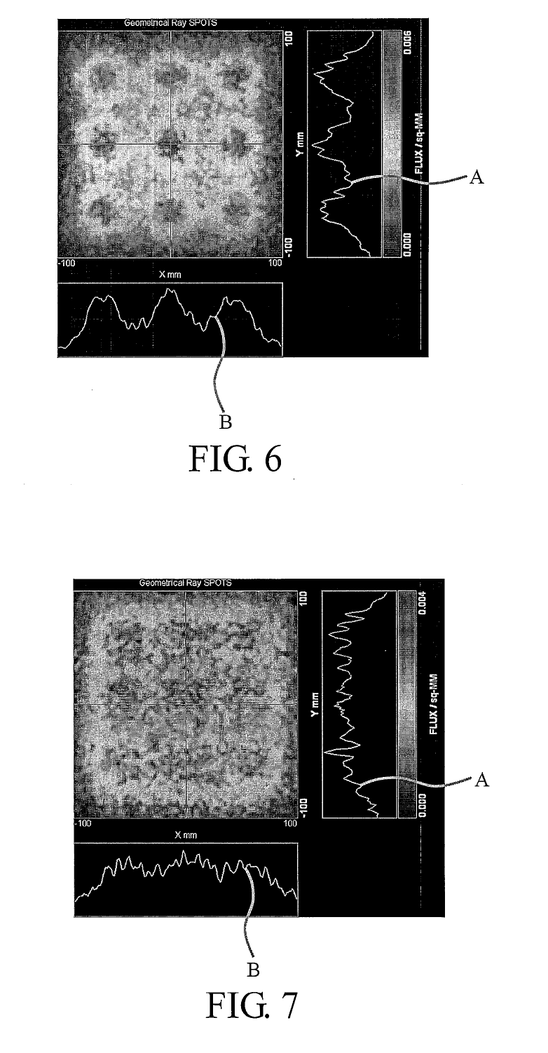

FIG. 6 is a luminous energy distribution diagram of a backlight module without the mixing light plate. In FIG. 6, curve A depicts luminous energy of y direction (ordinate axis) and curve B depicts luminous energy of x direction (abscissa axis). In an exemplary embodiment of 9 light-emitting diodes serving as light source of backlight module, it is found that curves A and B show a high luminous energy in central area of light source and a low luminous energy in peripheral area of light source.

FIG. 7 is a luminous energy distribution diagram of a backlight module with a mixing light plate according to the embodiments of the invention. In FIG. 7, curve A depicts luminous energy of y direction (ordinate axis) and curve B depicts luminous energy of x direction (abscissa axis). In an exemplary embodiment of 9 light-emitting diodes serving as light source of backlight module, it is found that curves A and B show a uniform luminous energy in central and peripheral areas of light source. Furthermore, compared with the backlight module without mixing light plate, a quantity of light (an area under curve A or B) of the backlight module with mixing light plate according to the embodiments of the invention may not reduce because of mixing light plate. Thus, luminescence efficiency of the backlight module is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a frame;
a plurality of light-emitting diodes disposed on a bottom surface of the frame; and
a mixing light plate disposed over the light-emitting diodes.

2. The backlight module as claimed in claim 1, further comprising a reflective layer formed on the bottom surface and an inner sidewall of the frame.

3. The backlight module as claimed in claim 1, wherein the light-emitting diodes comprise white light-emitting diodes or an array of blue, green and red light-emitting diodes.

4. The backlight module as claimed in claim 1, further comprising a diffusion plate disposed on the mixing light plate.

5. The backlight module as claimed in claim 4, wherein a first distance between the mixing light plate and the bottom surface of the frame is longer than a second distance between the mixing light plate and the diffusion plate.

6. The backlight module as claimed in claim 4, wherein a first distance between the mixing light plate and the bottom surface of the frame is less than or equal to two third of a second distance between the diffusion plate and the bottom surface of the frame.

7. The backlight module as claimed in claim 1, wherein the mixing light plate comprises:
a substrate; and
a patterned layer comprising reflective material formed on a surface of the substrate.

8. The backlight module as claimed in claim 7, wherein the surface of the substrate comprises a plurality of mixing light pattern units corresponding to the light-emitting diodes respectively, each mixing light pattern unit having a central area close to the light-emitting diode and a peripheral area far from the light-emitting diode.

9. The backlight module as claimed in claim 8, wherein the central area has a distribution density of the patterned layer more than that in the peripheral area.

10. The backlight module as claimed in claim 8, wherein the central area has transparency less than that of the peripheral area.

11. The backlight module as claimed in claim 7, wherein the substrate comprises glass or polymer.

12. The backlight module as claimed in claim 1, wherein the mixing light plate comprises:
a substrate; and
a patterned layer comprising opaque material formed on a surface of the substrate.

13. A liquid crystal display device, comprising:
a frame;
a plurality of light-emitting diodes disposed on a bottom surface of the frame;
a mixing light plate disposed over the light-emitting diodes;
a diffusion plate disposed on the mixing light plate; and
a liquid crystal display panel disposed on the diffusion plate.

14. The liquid crystal display device as claimed in claim 13, further comprising a brightness enhancement film disposed between the diffusion plate and the liquid crystal display panel.

15. The liquid crystal display device as claimed in claim 13, wherein the light emitting diodes comprise white light-emitting diodes or an array of blue, green and red light-emitting diodes.

16. The liquid crystal display device as claimed in claim 13, wherein a first distance between the mixing plate and the bottom surface of the frame is longer than a second distance between the mixing plate and the diffusion plate.

17. The liquid crystal display device as claimed in claim 13, wherein a first distance between the mixing plate and the bottom surface plate is less than or equal to two third of a second distance between the diffusion plate and the bottom surface of the frame.

18. The liquid crystal display device as claimed in claim 13, wherein the mixing plate comprises:
a substrate; and
a patterned layer comprising reflective material formed on a surface of the substrate.

19. The liquid crystal display device as claimed in claim 18, wherein the surface of the substrate comprises a plurality of mixing light pattern units corresponding to the light-emitting diodes respectively, each mixing light pattern unit having a central area close to the light-emitting diode and a peripheral area far from the light-emitting diode.

20. The liquid crystal display device as claimed in claim 19, wherein the central area has a distribution density of the patterned layer more than that in peripheral area.

21. The liquid crystal display device as claimed in claim 19, wherein the central area has lower transparency than that of the peripheral area.

22. The liquid crystal display device as claimed in claim 13, wherein the mixing light plate comprises:
a substrate; and
a patterned layer comprising opaque material formed on a surface of the substrate.

23. The liquid crystal display device as claimed in claim 13, further comprising a reflective layer formed on the bottom surface and an inner sidewall of the frame.

24. A method for fabricating a backlight module, comprising:
providing a frame having a first reflective layer formed therein;
disposing a plurality of light-emitting diodes on a bottom surface of the frame; and
disposing a mixing plate over the light-emitting diodes.

25. The method as claimed in claim 24, further comprising forming a patterned layer comprising reflective material on the mixing light emitting plate.

26. The method as claimed in claim 25, wherein the patterned layer comprising reflective material is formed by screen printing or inkjet printing.

27. The method as claimed in claim 25, wherein forming the patterned layer comprises:
forming a second reflective layer on the mixing plate; and
patterning the second reflective layer to form the patterned layer on the mixing plate.

28. The method as claimed in claim 27, wherein the second reflective layer is formed by sputtering, evaporating or plasma enhanced chemical vapor deposition.

29. The method as claimed in claim 27, wherein patterning the second reflective layer is performed by laser direct writing or lithographic.
